(19) United States
(12) Patent Application Publication
(10) Pub. No.: US 2014/0068706 A1
(43) Pub. Date: Mar. 6, 2014

(54) Protecting Assets on a Device

(71) Applicant: Selim Aissi, Menlo Park, PA (US)

(72) Inventor: Selim Aissi, Menlo Park, PA (US)

(21) Appl. No.: 14/012,597

(22) Filed: Aug. 28, 2013

Related U.S. Application Data
(60) Provisional application No. 61/694,140, filed on Aug. 28, 2012.

(51) Int. Cl. G06F 21/60

(52) U.S. Cl. CPC G06F 21/60
USPC 726/1; 726/26

(57) ABSTRACT

Embodiments of the present invention are directed to systems and methods for protecting data assets on a device. In embodiments of the invention, a data protection module dynamically and statically searches for one or more data assets and identifies the data assets based on one or more security and privacy attributes. The data assets are classified based on a policy and protected using one or more protection mechanisms. Additionally, data assets are ranked and a security and privacy map is generated and maintained. The security and privacy map may include association of the data assets with their location, ranking, protection mechanism, etc. In some embodiments, a user interface is provided on the device for viewing and generating the policy and/or the security and privacy map.

### CROSS-REFERENCES TO RELATED APPLICATIONS

This application is a non-provisional application and claims the benefit of priority of U.S. Provisional Application No. 61/694,140 titled “Protecting Assets on a Device,” and filed on Aug. 28, 2012, which is herein incorporated by reference in its entirety for all purposes.

### BACKGROUND

Embodiments of the invention are directed to systems and methods for protecting data assets on a device.

Devices, such as mobile devices, continuously store and interact with security sensitive data that may be at rest, in-use or in transit. Sensitive data can be stored all across the device and can be controlled by multiple applications. Sensitive data may also be provided to the device through user input, cameras, applications, email, removable media, etc. Sensitive data may include sensitive user information (financial or personal), geo-location data, cryptographic data, etc.

As a user's reliance on his or her mobile device increases (e.g., for payment and other functions), the amount of sensitive information that is stored on the mobile device increases. The increase in the amount of sensitive data that is stored on mobile devices results in the need for better data security systems and methods for mobile devices.

Today, the user has limited ways to monitor and protect all of their data assets on a mobile device. Most current solutions are directed towards detecting a malicious intrusion or malicious behavior on the device. Current solutions do not provide data protection based on the awareness of the environment associated with the data. For example, data protection associated with a wallet application may have different requirements than data protection for other types of applications (e.g., a medical application) as the applications are installed or executed. Current data protection solutions are reactive rather than proactive, and are independent of the application or environment associated with the data.

Embodiments of the invention address this and other problems, individually and collectively.

### BRIEF SUMMARY

Embodiments of the invention are directed to systems and methods for protecting data on a device based on the awareness of the environment associated with the data. In embodiments of the invention, a data protection module dynamically and statically searches for one or more data assets and identifies the data assets based on one or more security and privacy attributes. The identified data assets are classified based on a policy that may be set by one or more entities. The classified data assets may be protected using one or more protection mechanisms based on the policy. Further, the data assets are ranked and a security and privacy map is generated and maintained. The security and privacy map may include association of the data assets with their location, ranking, protection mechanism, etc. In some embodiments, a user interface is provided on the device for viewing and generating (e.g., updating) the policy and/or the security and privacy map.

One embodiment of the invention is directed to a method for protecting data assets on a computing device, wherein the method comprises searching, by a data protection module run by a processor, for at least one data asset on the computing device. The method also includes identifying, by the data protection module run by the processor, the at least one data asset based on at least one attribute associated with the at least one data asset, and classifying the at least one data asset, and generating (e.g., updating) a map using the classification of the data asset.

One embodiment of the invention is directed to a computing device comprising a processor, a computer readable medium coupled to the processor, the computer readable medium comprising code, executable by the processor for implementing a method, wherein the method comprises searching, by a data protection module, for at least one data asset on the computing device, identifying, by the data protection module, the at least one data asset based on at least one attribute associated with the at least one data asset, classifying the at least one data asset, and generating (e.g., updating) a map using the classification of the data asset.

Another embodiment of the invention is directed to a system comprising a server computer and a computing device communicatively coupled to the server computer through a communications network, the computing device comprising a processor and a computer readable medium coupled to the processor, the computer readable medium comprising code, executable by the processor for implementing a method, wherein the method comprises searching, by a data protection module, for at least one data asset on the computing device. The method also includes identifying, by the data protection module, the at least one data asset based on at least one attribute associated with the at least one data asset, classifying the at least one data asset, and generating (e.g., updating) a map using the classification of the data asset.

These and other embodiments of the invention are described in further detail below.

### BRIEF DESCRIPTION OF THE DRAWINGS

FIG. 1 shows an exemplary device and various exemplary data assets associated with the device.

FIG. 2 shows an exemplary system, in one embodiment of the invention.

FIG. 3 illustrates at least some of the elements of an exemplary mobile device, in one embodiment of the invention.

FIG. 4 shows an exemplary computer readable medium in accordance with some embodiments of the invention.

FIG. 5 illustrates a table including data types, attributes and classifications, in one embodiment of the invention.

FIGS. 6A-6B illustrate a security and privacy map in one embodiment of the invention.

FIG. 7 illustrates a flow diagram, illustrating a method for protecting data assets on a device, in one embodiment of the invention.

FIGS. 8A-8B illustrate a user interface provided on a mobile device, in one embodiment on the invention.

FIG. 9 is a block diagram of a computer apparatus.

### DETAILED DESCRIPTION

Embodiments of the invention are directed to systems and methods for protecting data assets on a device.

When an application is downloaded, installed or executed on a device, the application may interact with other applications or data on the device or external to the device. For example, when a wallet application is installed on a mobile device, the wallet application may interact with the secure element of the mobile device to access security sensitive data (e.g., account information, personal information, cryptographic data, etc.). Additionally, when a transaction is conducted using the wallet application, the wallet application may interact with one or more servers computers (e.g., operated by a cloud, wallet provider, merchant, financial institutions, etc.) using one or more communication channels. As a result, security sensitive data may be logged in different memory locations all across the mobile device, such as, cache, RAM, secure element, removable media, or other memory locations on the mobile device.

Further, as an application interacts with other applications or data on the device or external to the device, new data may be generated or the data associated with the application may change, thus changing the characteristics of the data or metadata associated with the data. For example, when the wallet application sends transaction data to a payment processor for authorization, cryptographic keys or certificates may be generated and stored in a memory location (e.g., secure element) on the mobile device. In another example, security sensitive data, such as, geo-location data, contacts, etc. may be logged in various memory locations on the device as the mobile device is used by a user.

Current data protection solutions use reactive measures rather than proactive techniques for protecting data on the device. For example, sensitive data may be collected on a mobile device and a pre-determined action may be performed to protect the important data based on a situation. Current solutions do not provide data protection based on the awareness of the environment associated with the data. For example, during installation or execution, a data protection technique associated with a payment application may have different requirements than a data protection technique for a medical application.

Embodiments of the invention provide data protection based on the awareness of the environment associated with the data. For example, when an application is installed on a device, the application becomes aware of the data stored in different locations on the device, such as, the secure element, cache, RAM, ROM, etc. In addition, the application dynamically monitors the change in the environment associated with the data, as data is updated or new data is received due to interaction with other applications or data. For example, for a wallet application, embodiments of the invention may evaluate if a sixteen digit number provided by a user of the mobile device (e.g., using the device's keypad) may be a payment account number (e.g., credit card number) and protect the number using a suitable protection mechanism. Similarly, a four digit number provided by the user may be evaluated for a possible PIN entry and protected using a suitable protection mechanism.

In embodiments of the invention, a data protection module associated with the application may protect the data based on the environment it is associated with and the characteristics of the data itself. The data protection module may be configured to protect data at-rest, data in-use and data in-transit by dynamically and statically searching, identifying, and classifying all the data assets based on a policy. The data protection module may also generate and maintain a security and privacy map of the data assets on the device. The data protection module may further rank the assets and provide automatic and manual cryptographic controls or mechanisms for protecting the assets.

Embodiments of the invention provide intelligence to the application by being aware of the environment in which the application is downloaded, installed and/or executed on a device. For example, by being aware of the state of the data (in-use, in-transit or at-rest) across the device, the data protection module may pro-actively protect the data by using an appropriate protection mechanism.

An application that is unaware of the environment or the sensitivity of the data may store the data in memory for persistency when a phone is shut down so that the data is available when the device is tuned back on. In another example, if a TLS session is shut down, sensitive data, such as, cryptographic keys, may be stored on the device to be used for subsequent re-authentication. Such data may be logged across the device and will stay unprotected, thus, compromising the security of the sensitive information. Embodiments of the invention solve this problem by searching for and identifying such data and providing appropriate cryptographic controls/mechanisms based on a classification.

Prior to discussing embodiments of the invention, description of some terms may be helpful in understanding embodiments of the invention.

A “computing device” may comprise any electronic device that may be operated by a user, which may also provide remote communication capabilities to a network. The computing device may be configured to enable a user download an application from a server (e.g., web server) via a communication network (e.g., the Internet). The computing device may further be configured to install and execute one or more applications. Examples of computing devices include mobile devices (e.g. cellular phones), personal computers, PDAs, tablet computers, net books, laptop computers, personal music players, hand-held specialized readers, etc.

A “user” may be an entity, such as, an individual that may be associated with one or more personal accounts and/or computing devices. The user may be able to download an application, such as a wallet application and initiate installation of the application on a computing device. Furthermore, through a user interface provided by the computing device, the user may be capable of viewing and/or updating the policies and a security and privacy map for data protection.

A “data asset” may include security sensitive data on a computing device that may require protection. For example, a data asset may include sensitive information associated with a user, such as, the user's personal information (Personal Identifying Information) such as a home address, e-mail address, phone number, etc., or financial information (Personal Account Information) such as a primary account number, expiration date or CVV2 value for a payment card-type account. In another example, a data asset may include or be associated with certificates or cryptographic keys stored on the device. In yet another example, a data asset may include geo-location associated with the device. Thus, data assets may include information that is specifically entered into the mobile device by the user or may include information that is obtained or generated by the computing device, independent of specific user input. In this specification, terms “data asset”, “data” and “asset” may be used interchangeably.

“Searching” may be part of a data asset discovery process and may include scanning for data assets on a computing device. In one embodiment, the searching may include a scan of all the storage locations on the computing device, e.g., cache, RAM, flash ROM, secure element, databases, removable media (flash card, secure digital card, memory stick, etc.), etc. In some embodiments, searching may include looking for data at-rest (e.g., data stored on a disc, cache, databases, or other types of storage media, etc.), data in-use (e.g., data currently being processed by an application in the cache or RAM, data on display or decrypted data in any transient state) and data in-transit (e.g., data moving between two entities between same or different environments, such as, a web application and a database server) to determine which data needs to be protected.

“Identifying” may include recognizing a type of data based on a characteristic or a property (attribute) of the data. For example, identifying a payment account number may include recognizing that a number is a sixteen digit number and the first six digits of the number include a valid “issuer identification number” or a “bank identification number”, and the remaining twelve digits include an account identifier of a variable length. For example, the issuer identification number may indicate if the issuing network is Visa®, American Express®, Master Card®, Discover®, Diners Club®, and such. In some embodiments, identifying may also determine the type of data based on some other data associated with it. For example, in order to determine a valid credit card number, embodiments of the invention may use expiration date, security code (e.g., card security code, card verification value (CVV or CVV2), card verification value code (CVVC), verification code, etc. associated with the sixteen digit number.

An “attribute” may include a characteristic of the data. In some embodiments, an attribute may imply a data type such as, numeric, a string of text, an image, an audio file, etc. In some embodiments, the attribute may also imply a sub-category of the data type. For example, if a number is a four digit number, it could be identified as a PIN, whereas, if the number is a sixteen digit number, it could be identified as a payment account number, and if the number is a nine digit number, it could be identified as a social security number. In another example, an attribute may imply that the data is a key that may be associated with an encryption mechanism.

“Classifying” may include categorizing the data based on a certain criteria. In one embodiment, the criteria are based on a policy that may be set by an entity. For example, the data may be classified as highly sensitive, sensitive, important or not sensitive based on a policy for security sensitive data. Highly sensitive data may include cryptographic data, Personal Account Information (PAI), such as account numbers, security codes, expiration dates, and Personal Identifying Information (PII), such as social security number, billing address, user name, date of birth, bio-metric data, etc. Non-sensitive data may include music, settings, etc. In some embodiments, the data is classified so that an appropriate protection mechanism may be provided for each data asset based on its classification. For example, highly sensitive data assets may be encrypted, whereas, important data assets may be masked. In some embodiments, data assets in a certain classification may further include sub-classifications for providing appropriate data protection. In one embodiment, sub-classification may be based on a state of the data (at-rest, in-use or in-transit). For example, highly sensitive data may be encrypted if it's data at-rest, or tokenized, if it's data in-transit.

A “policy” may include a set of rules. In one embodiment, the policy includes a set of rules for protecting the security sensitive data on a computing device. In some embodiments, data assets on a computing device are searched, identified, classified and protected based on a policy set by one or more entities. For example, a policy may include rules for scanning various memories on the device for security sensitive information, identifying the information based on certain attributes and classifying the information for providing appropriate protection mechanism to protect the sensitive information. The entity may be a financial institution (e.g., bank), a payment processing network, an application owner, a user or any additional service provider.

A “ranking” may imply a position of a data asset relative to other data assets on a scale. For example, on a scale of 10, a ranking of a data asset may be “1”, whereas, a ranking for another data asset may be “5.” In one embodiment, a raking of “1” may imply a highly sensitive data asset, whereas, a ranking of “10” may imply non-sensitive data asset. In some embodiments, ranking of the data assets may be generated (which may include updating) by a user of the computing device using a graphical user interface.

A “map” may include an association of one or more data assets on a computing device with one or more other aspects of the data or computing device. In one embodiment, the map may be implemented in a database as a table that associates the data assets with their location, type, ranking, and protection mechanism for easy access. In some embodiments, an interface may be provided to a user to view the graphical representation of the security and privacy map including all the data assets on the device.

A “server computer” may typically be a powerful computer or cluster of computers. For example, the server computer can be a large mainframe, a minicomputer cluster, or a group of servers functioning as a unit. In one example, the server computer may be a database server coupled to a web server.

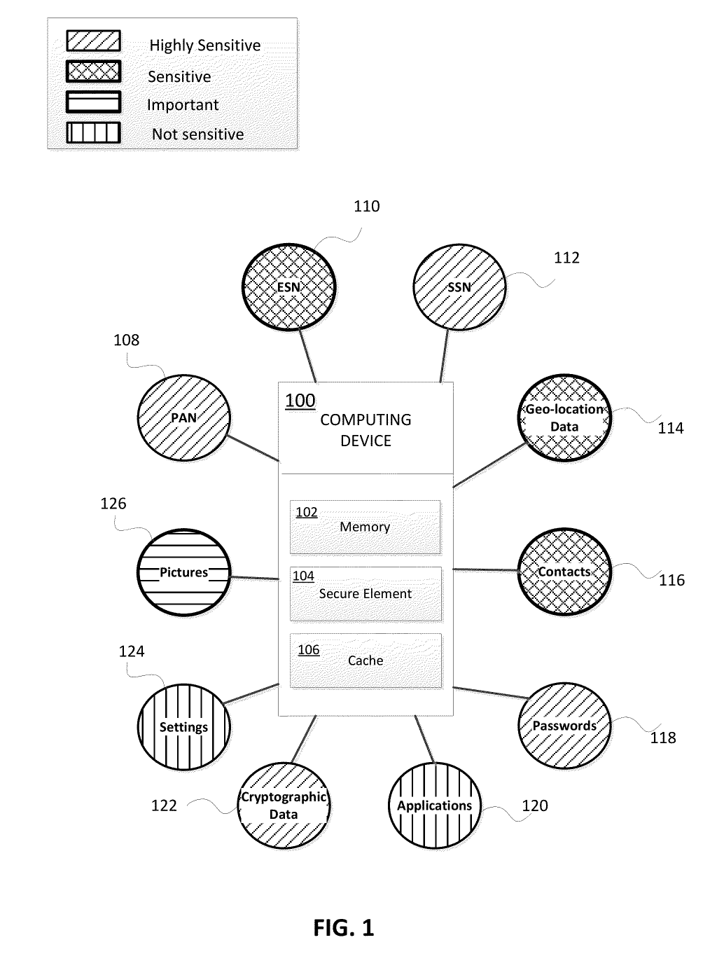

FIG. 1 illustrates various exemplary data assets associated with a computing device 100.

The exemplary computing device 100 may be associated with various exemplary data assets stored across the device, such as a PAN 108, an Electronic Serial Number (ESN) 110, Social Security Numbers (SSN) 112, geo-location data 114, contacts 116, passwords 118, application/application data 120, cryptographic data 122, settings 124 and pictures 126. These data assets are merely examples and embodiments of the invention are not limited to these specific data assets.

The exemplary data assets may be stored in various storage units on the computing device 100 that may include volatile or non-volatile memory. Volatile memory is memory that requires power to maintain the stored information (e.g., SRAM, DRAM, etc.). Non-volatile memory is memory that can retain the stored information even when not powered. Examples of non-volatile memory include read-only memory (see ROM), flash memory, most types of magnetic computer storage devices (e.g. hard disks, floppy discs and magnetic tape), optical discs, etc.

In one embodiment, the sensitive information may reside in a memory 102, a secure element 104 or/and a cache 106 that may use volatile or non-volatile memory. Additionally, sensitive information may be stored on removable media (not-shown), such as Secure Digital Cards, MicroSD, MultiMedia Cards, SIM, memory cards, etc.

In some embodiments, the memory 102 may include a non-volatile, non-writable storage area (e.g., Flash ROM) where the firmware/operating system may reside. In some embodiments, the memory 102 may include RAM where volatile run-time memory may reside. The cache 106 may store frequently accessed data that may be needed in the near future (e.g. proxies). The secure element 104 may be used for storing/executing secure applications (e.g., wallet application) and/or storing data (e.g., cryptographic data for key management, PAI, PII, etc.). The secure element 104 may refer to a trusted environment (e.g., in hardware or software) for storing sensitive data or applications. The secure element 104 may store tamper detection software, and may store a root of trust, a cryptographically secure random number generator, encryption keys, etc.). It is to be noted that the memory on the computing device 100 may be implemented in any suitable manner and may include a combination of different types of memory storage.

In some embodiments, different data assets stored across the mobile device 100 may be searched, identified, classified and protected based on a policy. For example, the SSN 112, passwords 118, cryptographic data 122 and the PAN 108 may be classified as highly sensitive and protected using a first protection mechanism (e.g., encryption). Next, the ESN 110, geo-location data 114, and contacts 116 may be classified as sensitive and protected using a second protection mechanism (e.g., de-contexting). Next, the pictures 126 may be classified as important and protected using a third protection mechanism (e.g., masking). Finally, the apps 120 and the settings 124 may be classified as not sensitive and protected using a fourth protection mechanism (e.g., hashing).

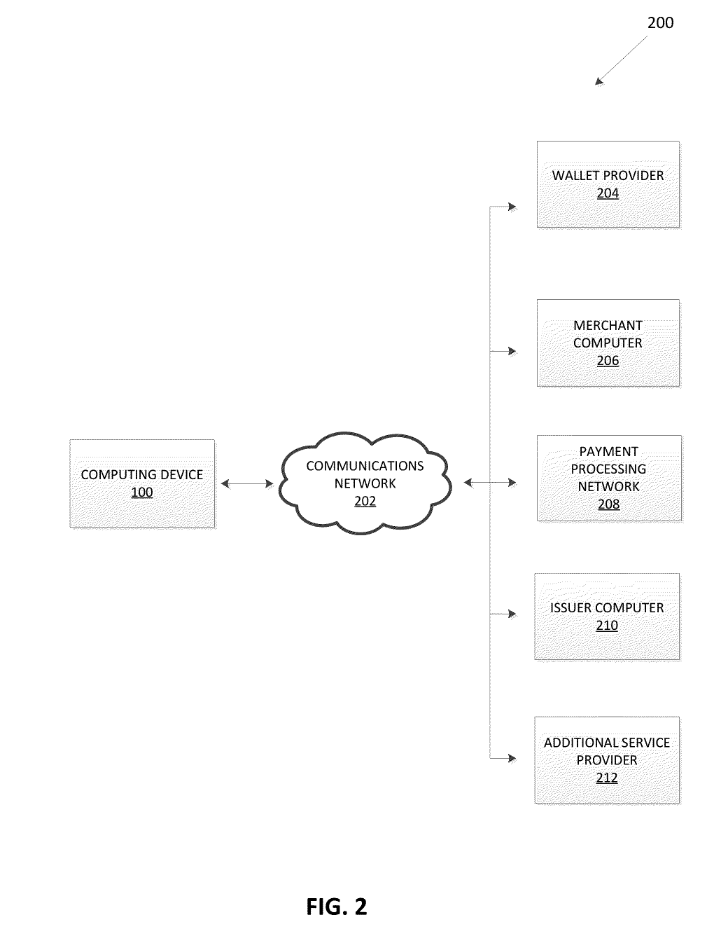

FIG. 2 shows an exemplary system 200, in one embodiment of the invention.

The exemplary system 200 may include the computing device 100, a wallet provider 204, a merchant computer 206, a payment processing network 208, an issuer computer 210, and an additional service provider 212. However, embodiments of the invention are not limited to the exemplary configuration of the system 200 and any other configuration with other components is possible.

The computing device 100 may be configured to communicate with the wallet provider 204, merchant computer 206, payment processing network 208, issuer computer 210, additional service provider 212 or other entities via a communication network 202 as required/supported by plurality of applications that may be installed on the computing device 100 or executed by the computing device 100. The communication network 202 may include one or more networks and may be based on Internet Protocol (e.g., WiFi 802.11) or any such suitable type of communication protocol.

The computing device 100 may interact with many entities for managing accounts, making payments, or a variety of other tasks that may involve accessing, updating, receiving and transmitting user sensitive information. For example, the user may make a payment at a point of sale terminal or online with a merchant associated with the wallet provider 204 or the merchant computer 206 and in the process share credit card (or other payment device) information with the merchant. The user may manage their online credit card accounts with a credit card issuer associated with the issuer computer 210 or may connect to the payment processing network 208 to manage and authorize transactions. The user may also connect to the additional service provider 212, through their computing device 100, for managing bank accounts, medical records, pre-paid accounts, rewards, mortgage accounts, and so on.

In accessing some of the services mentioned above, the user may download and install applications that connect with one or more entities and accesses, updates, stores, receives and transmits user sensitive information. The user may download the applications from any of the entities or a developer/owner of the application or an internet website.

In some embodiments, the wallet provider 204 may be configured to provide a payment application (e.g., wallet application) that may be installed on the computing device 100 for conducting financial transactions using the computing device 100. In some embodiments, the wallet provider 204 may be configured to work with an authentication server for authenticating the computing device 100 and the user. The wallet provider 204 may also be configured to connect with various merchants/merchant billing systems.

The merchant computer 206 may be associated with a merchant for providing sale of goods and/or services. In some embodiments, the user can purchase goods and/or services by logging on to a website associated with the merchant or at a POS terminal coupled to the merchant computer 206. In some embodiments, the merchant computer 206 may have a business relationship with an acquirer computer (not shown) that may be associated with a bank. The acquirer computer may route the authorization request for a transaction to the issuer computer 210 via the payment processing network 208.

The payment processing network 208 may be configured to provide authorization services, and clearing and settlement services for payment transactions. The payment processing network 208 may include data processing subsystems, wired or wireless networks, including the internet. An example of payment processing network 208 includes VisaNet®, operated by Visa®. In some implementations, the payment processing network 208 may interact with applications running on a computing device. The payment processing network may include a server computer.

The issuer computer 210 is typically a computer run by a business entity (e.g., a bank) that may have issued the payment (credit/debit) card, account numbers or payment tokens used for payment transactions conducted using the computing device 100. In some embodiments, the business entity (bank) associated with the issuer computer 210 may also function as an acquirer.

The additional service provider 212 may be associated with one or more entities for performing various functions, such as, validation, data storage, application provider/owner, third party vendor, etc. In some embodiments, the additional service provider 212 may be configured to communicate with one or more components of the system 200. In some embodiments, the additional service provider 212 may provide authentication services for authenticating a PIN used by a user of the computing device 100 for conducting a transaction or accessing an account. In some embodiments, the additional service provider 212 may be coupled to a database for storing security sensitive data associated with financial transactions or medical records.

As security sensitive data on the computing device 100 is updated or added due to interaction with various components of the system 200, or due to interaction with other applications or data on the computing device itself, embodiments of the invention statically and dynamically search for the data, identify the data and classify it for providing a suitable protection mechanism.

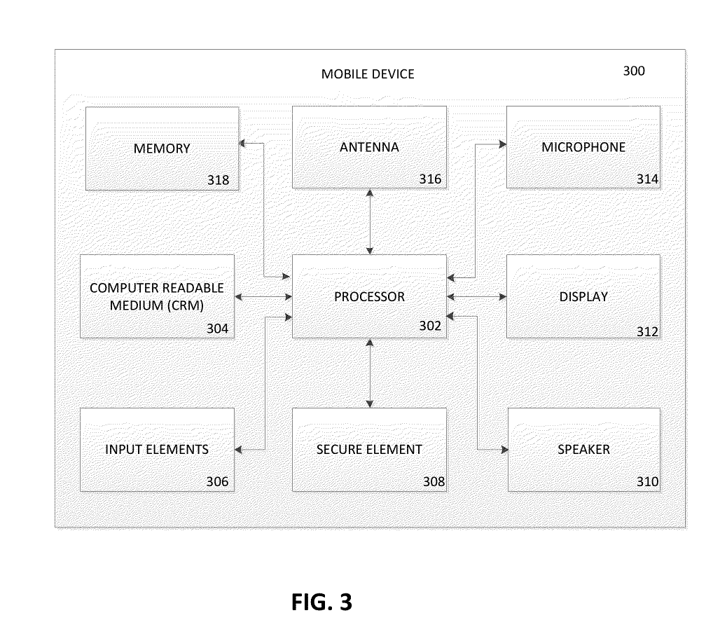

FIG. 3 illustrates at least some of the elements of an exemplary mobile device 300 that may be used as the computing device 100 in embodiments of the invention. The mobile device 300 may comprise a computer readable medium (CRM) 304, an antenna 316, a microphone 314, a display 312, a speaker 310, a contactless element 308, input elements 306, a memory 318 and these may all be operatively coupled to a processor 302.

The mobile device 300 may be a mobile phone, a tablet, a PDA, a laptop or any such electronic device capable of communicating and transferring data or control instructions via a wireless network (e.g., cellular network, internet, etc.) and short range communications. In some embodiments, the mobile device 300 may be configured as a communication device that can allow a user to log on to a website and download an application and/or run different applications. In some embodiments, the mobile device 300 may also be configured as a payment device that may be used to make payments, conduct a transaction, etc.

The mobile device 300 may also be configured to communicate with a mobile network operator via a cellular network (not shown). The mobile network operator may be configured to provide cellular services to a user of the mobile device 300 and may work with one or more mobile virtual network operators to provide voice, data, multimedia or any such services to the user. The cellular network may utilize wireless communication protocols, such as CDMA, GSM, 3GPP, 3GPP2, LTE or any other suitable communication protocol.

The exemplary mobile device 300 may comprise the CRM 304 comprising code executable by the processor 302 for implementing methods using embodiments of the invention. In one embodiment, the processor 302 may be configured for processing the functions of a phone. The CRM 304 may be in the form of a memory that stores data and could be internal to the mobile device 300 or hosted remotely (i.e., cloud) and accessed wirelessly by the mobile device 300. In some embodiments, the CRM 304 may include non-volatile, non-writable storage area (e.g., Flash ROM) where the firmware/operating system may reside. In some embodiments, the memory 318 may include RAM where volatile run-time memory may reside and/or a cache (e.g., cache 106).

The secure element 308 may be implemented as a separate secure smart card chip, in a SIM/UICC, or in a removable card (e.g., Secure Digital card). The secure element 308 may be configured to securely store applications (e.g., wallet application), data (e.g., PAI, PII, cryptographic data for key management) and provide for secure execution of applications. In some embodiments, the secure element 308 may be used for contactless transactions by transmitting and receiving wireless data or instructions using a short range wireless communications capability (e.g., Near Field Communications).

The speaker 310 may be configured to allow the user hear voice communication, music, etc., and the microphone 314 may be configured to allow the user transmit her voice through the mobile device 300.

The display 312 may allow a user to view text messages, phone numbers, images, and other information. In some embodiments, a graphical user interface may be provided on the display 312 for the user to view a security and privacy map of the data assets. In some embodiments, the user can view or update the policies for data search, identification and protection using the graphical user interface.

The input elements 306 may be configured to allow the user to input information into the device (e.g., using a keypad, touch screen, mouse, etc.). For example, the user may use a keypad or touch screen to provide a credit card number, an expiration date, a CVV, a PIN, etc. to set up a wallet application. In some embodiments, the user may use the input elements 306 to set up or update a policy for protecting data assets on the mobile device 300. In some embodiments, the user may want to scrub all the data on the mobile device 300 (e.g., when switching to a new device) using the input elements 306 and the graphical user interface provided on the display 312.

The antenna 316 may be configured for wireless data transfer between the mobile device 300 and other entities, such as, the wallet provider 204, merchant computer 206, payment processing network 208, issuer computer 210, and additional service provider 212 via the communications network 202. In some embodiments, the antenna 216 may be used for downloading an application through the communications network 202 (e.g., the Internet) from a web server (e.g., associated with the wallet provider 204).

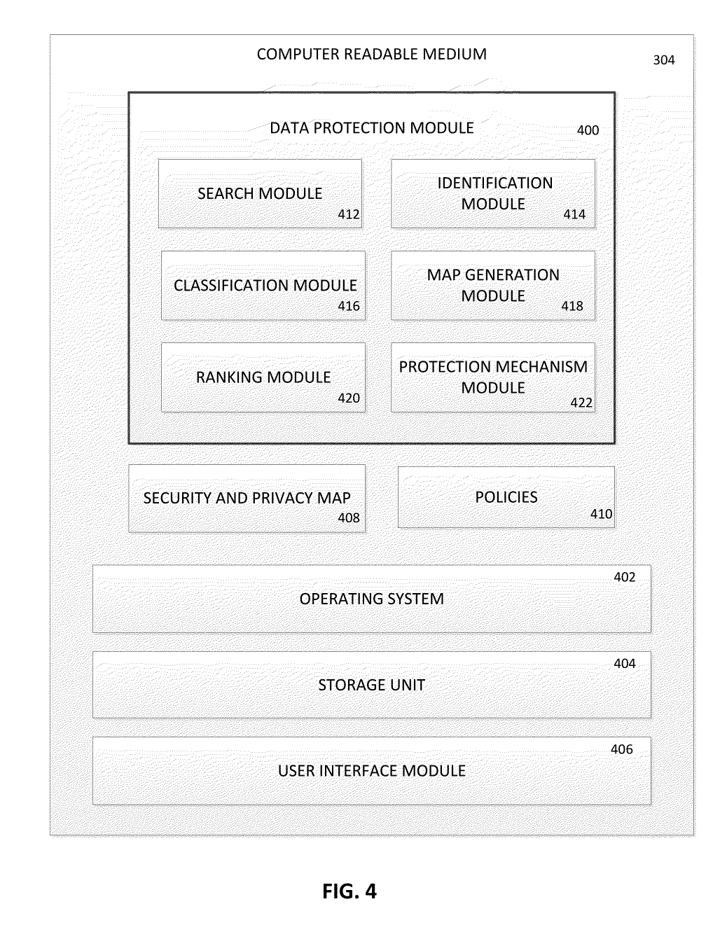

FIG. 4 shows an exemplary computer readable medium in accordance with some embodiments of the invention.

The computer readable medium (CRM) 304 may comprise code, executable by the processor 302 for implementing methods using embodiments of the invention. The computer readable medium 304 may comprise a data protection module 400, an operating system 402, a storage unit 404, a user interface module 406, a security and privacy map 408 and policies 410.

In embodiments of the invention, the data protection module 400 may be configured to protect data assets on the mobile device 300 based on a policy as determined by the policies 410 and maintain/update the security and privacy map 408 of the data assets on the mobile device 300. In one embodiment, the data protection module 400 is part of an application that may be downloaded/installed on the mobile device 300. For example, the data protection module 400 may be associated with a wallet application provided by the wallet provider 204. In one embodiment, the wallet application may be linked to one or more of a user's financial account, medical account, rewards card, prepaid card, gift card, and so on.

In one embodiment, the data protection module 400 is a standalone module that may be reside on the mobile device 300. In one embodiment, the data protection module 400 may be associated with one or more applications that may be hosted on a remote server (e.g., the merchant computer 206, payment processing network 208, issuer computer 210, and additional service provider 212, etc.).

In one embodiment, the data protection module 400 may be implemented as a module in the operating system kernel with high level of privilege and access to most of the system software, hardware and storage across the device. The data protection module 400 may be configured to work with security hardware hooks in the mobile device 300, such as, secure cryptographic and unique keys, encryption engines, and read/write privileges for access to device resources in embodiments of the invention. Embodiments of the invention may be implemented in the secure element of a device (e.g., secure element 308) or using other suitable means that would ensure a high level of security for the execution and storage of the application and data associated with the data protection module 400. In one embodiment, the integrity and authenticity of the data protection module 400 may be verified statically at boot time of the mobile device 300 or dynamically at run-time.

The data protection module 400 may also monitor the download and installation of new applications on the mobile device 300 and determine the sensitivity of the access of the application. In an example mobile device 300, using an operating system, in one embodiment, the data protection module 400 may monitor the manifest information associated with the application, such as privacy and security warnings in determining the privacy and security associated with the transactions and data associated with the application.

In one embodiment, the data protection module 400 may be connected over-the-air to a secure agent (e.g., the additional service provider 212) residing remotely. In the event that the mobile device 300 is misplaced, lost or stolen, the secure agent can enable the user to protect the various data assets on the device wirelessly by over-the-air removing credentials that would allow access to the sensitive information, or deleting the sensitive information all together.

In some embodiments, policies 410 may be determined by one or more entities, for example, the payment processing network 208, issuer computer 210, additional service provider 212 or a user of the mobile device 300. In some embodiments, the policies 410 may specify a set of rules for search, identification, classification and protection of security sensitive data. For example, a policy A may specify that all the data in the secure element should be encrypted and all the data in-transit should be masked. In another example, a policy B may specify that all the data associated with a payment application should be tokenized and a scan of all the memory locations on the device should be based on a scheduled basis. In some embodiments, policies may be set by one entity (e.g., application owner) may be updated by another entity (e.g., a user) but different entities may have different levels of restrictions for updating the policy. In one embodiment, the application owner may have fewer restictions than other entities to update the policies.

The operating system 402 may be a collection of software that manages computer hardware resources and provides common services for applications. The operating system 402 may be configured to enable the installation and execution of applications on the mobile device 300.

The data protection module 400 may further comprise a search module 412, an identification module 414, a classification module 416, a map generation module 418, a ranking module 420 and a protection mechanism module 422.

The search module 412 may be configured to discover privacy and security sensitive data on the mobile device 300. The search module 412 may be associated with a very high level of access privilege for reading the various storage locations, regardless of the access controls. In one embodiment, searching for data assets may include scanning/reading all the memory locations associated with the data at-rest, data in-use and data in-transit on the mobile device 300. For example, the search module 412 may scan the memory 318 and the secure element 308 for data at-rest. In some embodiments, the search module 412 may scan different components of the mobile device, for example, the input elements 306, speaker 310, display 312, microphone 314 and the antenna 316 for data in-use or data-in transit (e.g., the buffers associated with each component). In some embodiments, the search module 412 may scan the storage unit 404.

In some embodiments, the search module 412 may be configured to discover privacy and security sensitive data based on a policy. For example, based on the policy, the search for assets may occur occasionally, upon enabling of the data protection module 400 on the mobile device 300, trigerred by a request from the user (e.g., via the user interface) or an auto scheduler. In embodiments of the invention, data assets may be discovered statically and dynamically as various entities interact with the various data assets on the mobile device 300.

The identification module 414 may be configured to identify the data discovered by the search module 412 for security sensitive information. In one embodiment, the identification of the data is determined based on one or more attributes associated with the data. For example, an attribute may imply a data type (e.g., a number) or a sub-category of a data type (length of the number). The identification module 414 may identify the number as a security sensitive number (e.g., a PAN) if it is a sixteen digit number and the first six digits of the number correspond to a well known BIN (e.g. a well known bank may only have one six digit BIN that is well known). In another example, after searching a nine digit number may be located in a memory in the computing device, the first three digits of the nine digit number may correspond to the zip code of the user of the computing device. The identification module 414 may then infer that this data asset is a phone number. The identification module 414 may be used to analyze the data asset that has been located, and compare that analyzed data asset against data asset attributes stored in the computing device or elsewhere (e.g., at a remote server computer).

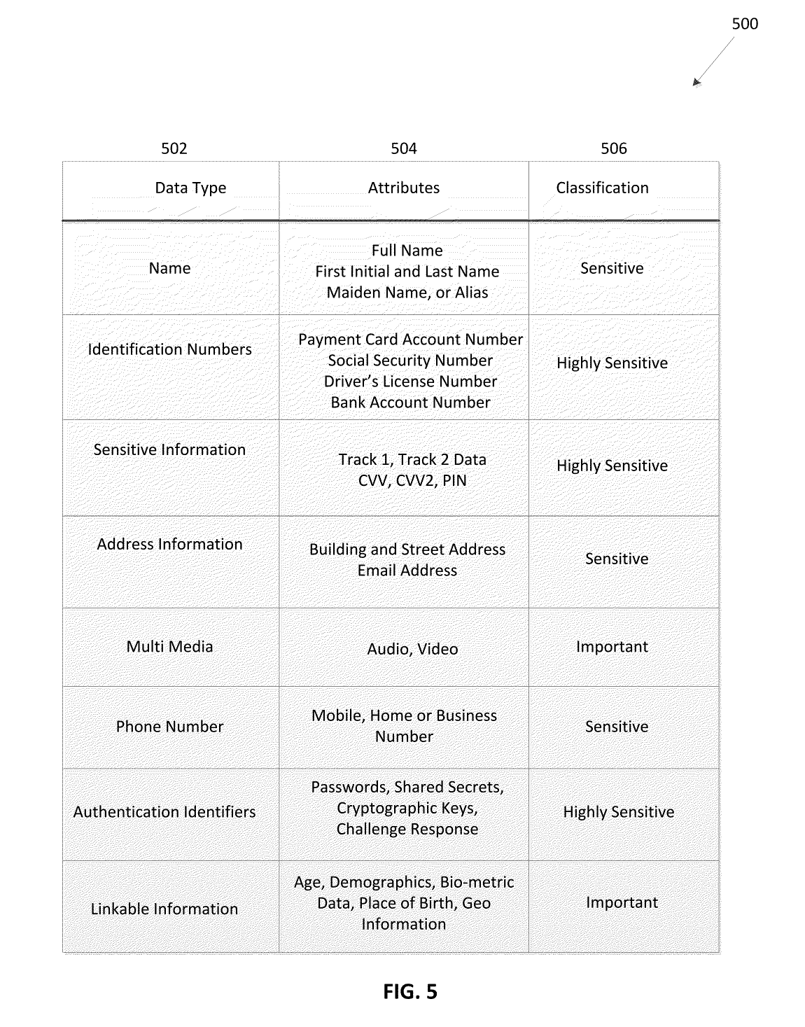

In some embodiments, the identification module 414 may be configured to identify a type of the data asset based on the security and privacy attributes associated with the data asset. For example, the identification module 414 may infer the privacy and security properties of the data based on the ownership of the data, the metadata associated with it, the location of the storage of the data (e.g., secure element, cache, etc.), association of the data with a security application (e.g., a payment application), analysis of the data itself or any other suitable means. This is explained further with reference to FIG. 5.

FIG. 5 illustrates a table 500 including a data type 502, attributes 504 and a classification 506.

As illustrated in the table 500, based on any of the attributes of the data asset, a corresponding data type may be identified. For example, based on the full name, first initial and last name, maiden name or an alias, a name may be identified. In another example, an identification number may be identified based on a payment card account number, a social security number, a driver's license number, a bank account number, etc. In some embodiments, multiple attributes, such as, age, demographics, bio-metric data, place of birth, geo location, etc. may be linked to identify a type of data asset.

In some embodiments, all the data assets stored in the secure element 308 (e.g., financial information, keys, certificates, etc.) may be identified as security sensitive data. In some embodiments, payment data (e.g., PAN, expiration date, CVV2) associated with a wallet application may be identified as security sensitive data.

Referring back to FIG. 4, the classification module 416 may be configured to classify the identified assets based on a policy. In one embodiment, classification of the assets includes, but is not limited to confidentiality, integrity, and authenticity of the data assets. For example, the data may be classified as highly sensitive, sensitive, important and not sensitive.

Referring back to FIG. 5, highly sensitive data may include identification numbers, sensitive information, and authentication identifiers. The sensitive data may include name, address information, and phone number. The important data may include multimedia and the linkable information.

Note that the exemplary classification of data assets, as shown in FIG. 5, may be different for different policies. For example, name and address information may be “sensitive” based on a first policy, “important” based on a second policy and “highly sensitive” based on a third policy. Further, in some embodiments, the classification 506 of the data assets may be updated by the user, using a user interface provided on the computing device 100.

In some embodiments, assets may be classified differently based on the meta data associated with the data assets. For example, if an expiration date and the CVV2 associated with the PAN 108 are located in the computing device, then the PAN 108 or the combination of data assets may be classified as highly sensitive and protected using a highly secure protection mechanism. However, if the expiration date and/or the CVV2 associated with the PAN 108 are not present or do not correspond to the PAN 108, then the PAN 108 may be classified as less sensitive and can be protected using a less secure data protection mechanism. In this example, an unauthorized person that is in possession of the PAN, as well as the corresponding expiration date and CVV2, can use this data to conduct unauthorized online transactions, whereas an unauthorized person could not conduct unauthorized online transactions using only a PAN without the expiration date and CVV2 value. Consequently, the PAN is more sensitive data when used in combination with the expiration date, and the CVV2, than when it is used alone. Thus, in embodiments of the invention, the data sensitivity of a data asset may depend upon the presence or absence of other data elements, as well as it location within the computing device and its inherent characteristics.

In some embodiments, assets may be classified based on a combination of data types. For example, the address information by itself may be classified as “sensitive” but in combination with name and “phone number” may be classified as “highly sensitive”. Accordingly, data protection may be different for combinations of data assets.

Referring back to FIG. 4, the map generation module 418 may be configured to generate and maintain a security and privacy map 408 of the data assets on the mobile device 300. In one embodiment, the security and privacy map 408 is implemented as a database that associates the data asset, data type, location of the data, and the protection mechanism for easy access. In some embodiments, a user interface is provided on the mobile device 300 (e.g., on the display 312) to interact with the data protection module 400 and graphically represent the security and privacy map 408 of the data assets across the mobile device 300 to the user. In one embodiment, the security and privacy map 408 may be communicatively coupled to the data protection module 400. In another embodiment, the security and privacy map 408 may be part of the storage 404.

The ranking module 420 may be configured to rank the assets based on the classification and sub-classification. For example, a data asset classified as highly sensitive may be ranked as “1”, whereas, another data asset classified as not sensitive may be ranked at “10”. It is to be noted that the above ranking is an exemplary ranking of the classified assets, and many differing ranking scales may be implemented. In some embodiments, the rankings may be adjusted and configured by the user using an interface provided by the protection module 400.

The protection mechanism module 422 may be configured to provide different types of protection mechanisms (or processes) based on the classification. In one embodiment, the protection mechanisms may include encryption, tokenization, masking, de-contexting, hashing, deletion, scrubbing, or any protection mechanism suitable for protecting security sensitive data. In one embodiment, the protection mechanism module 422 may automatically utilize the appropriate level of protection scheme in protecting the various data assets.

Encryption of the data may include encoding the data based on any known encryption algorithm, such as, AES (Advanced Encryption Standard), DES (Data Encryption Standard), Triple DES, RSA, ECC, etc. In some embodiments, the encryption may use an encryption key which specifies how the data is encrypted. In some embodiments, a certificate may be used in combination with the encryption for extra security.

Tokenization of the data may include replacing a number with a random value (token) to safeguard the data. In some embodiments, the token may be of the same type and same length as the original data and may contain certain elements of the original data. For example, a token for the sixteen digit payment account number can be sixteen digits long and may contain last four digits of the payment account number.

De-contexting of the data may include removing the context of the data for protecting the data. For example, a PAN may be linked to an expiration date and a security digit (e.g., CVV, CVV2, etc.) in the context of payment transactions. However, de-contexting may remove the association of the PAN with the expiration date and the security digit.

Hashing may be used to map a data string of an arbitrary length to a fixed-length. The hashing of the data may include generating a one-way hash of the data using a hash function or an algorithm (e.g., SHA-1, SHA-2, SHA-3, etc.). In some embodiments, data protection is provided by storing a hash of the security sensitive data rather than the data itself.

Masking of the data may include obfuscating some or all of the elements of the data. Some non-limiting examples of masking may include substitution, encryption, shuffling, deletion or nulling out, or any other suitable mechanism to anonymize the data.

Scrubbing or deletion of the data is the process of removing any security sensitive data such that it prevents any future re-identification. Embodiments of the invention may allow a user of the device to scrub all the security sensitive data on the device using a user interface, e.g., if the user wants to replace the device.

In some embodiments, data assets in each classification may be protected using a different protection mechanism. For example, data type with highly sensitive classification may be protected using more computational expensive techniques such as encryption. In addition, various types and strengths of encryption may be used for different data types (assets). Furthermore, sensitive data that may not be needed may be scrubbed from the system. For example, sensitive data associated with uninstalled applications that may still be residing in various locations on the device may be deleted. Similarly, the age and frequency of the access of the data may also be considered in deleting or prompting the user in deleting sensitive data from the system. For example, old and very rarely accessed data may be determined to be a good candidate for deletion.

In some embodiments, data protection may be provided based on a sub-classification of each data asset. For example, for each classification, there may be different protection mechanism applied to the data asset based on a state of the data (at-rest, in-transit or in-use). For example, sensitive data may be protected in transit using encryption but may be protected in-use by masking. In some embodiments, the data in-transit may be protected using encrypted and authenticated channels (e.g., Transport Layer Security (TLS), Secure File Transfer Protocol, File Transfer Protocol Secure, Secure Shell, etc.).

The user interface module 406 may be configured to provide a graphical user interface on the mobile device 300 (e.g., display 312) for allowing the user to view and update the security and privacy map 408 and policies 410. In some embodiments, the user interface module 406 is part of the data protection module 400. In one embodiment, the user interface module 406 may allow the user to take direct actions or weigh the decisions of the automatic protection of the various data assets. In one example, the user may want to scrub a certain class of data from the mobile device 300. For instance, if the user is replacing the mobile device 300, the user may want to scrub all sensitive information before giving up possession of the device. In one embodiment, the user may open the user interface for the data protection module 400 and view the graphical representation of the data across the device and select the specific data, data type, or ranking of data that the user may want to delete from the mobile device 300. Similarly, the user may select the specific data, data type, or ranking of data and adjust the protection mechanism used in protecting the data asset.

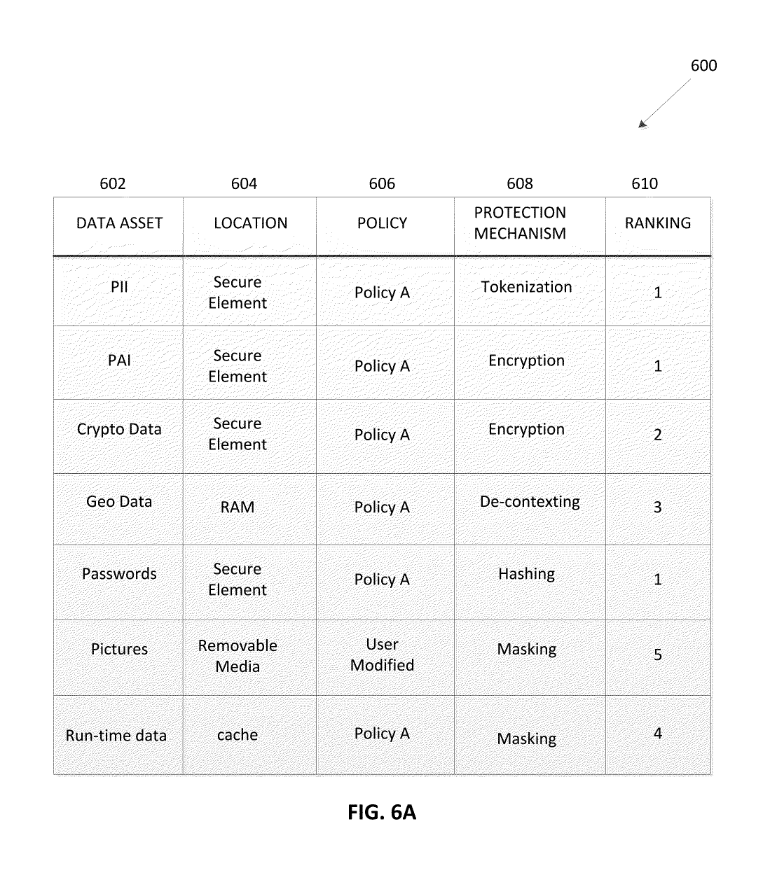

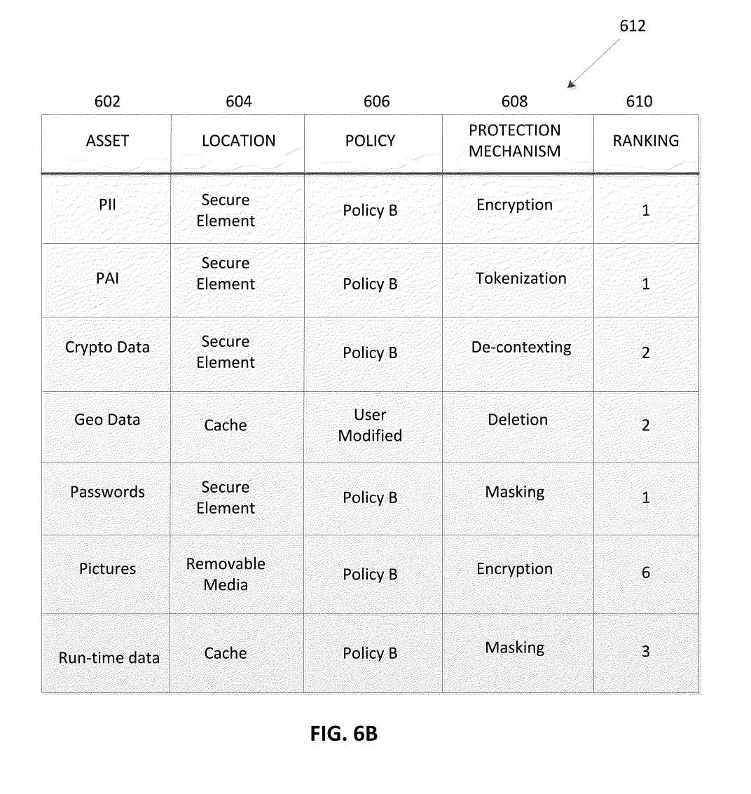

FIGS. 6A-6B illustrate a security and privacy map in one embodiment of the invention. Maps according to embodiments of the invention may include two or more rows of data and/or two or more columns of data in any suitable configuration.

As illustrated in FIG. 6A, a security and privacy map 600 includes a data asset 602, a location 604, a policy 606, a protection mechanism 608 and a ranking 610. For example, PII may be located in the secure element 308 and may be protected using tokenization based on a “Policy A.” Further, PII may be ranked as “1” based on “Policy A.” In another example, pictures may be located on the removable media and may be protected using masking based on a user modified policy. Further, pictures may be ranked as “5” based on the user modified policy.

As illustrated in FIG. 6B, in a security and privacy map 612, PII may be protected using encryption based on a “Policy B.” In another example, geo data may be protected using deletion based on a user modified policy. Further, ranking of data assets may be different based on different policies, as shown in the maps 600 and 612. For example, geo data may be ranked as “3” as shown in the map 600, and ranked as “2” as shown in the map 612.

In some embodiments, the user may be able to modify the policy 606, protection mechanism 608 and the ranking 610 for each asset 602 using a user interface. The user may choose what type of policy, protection mechanism, and/or ranking to associate with each type of data asset, based on the characteristics of the data asset itself or where it might reside in the computing device.

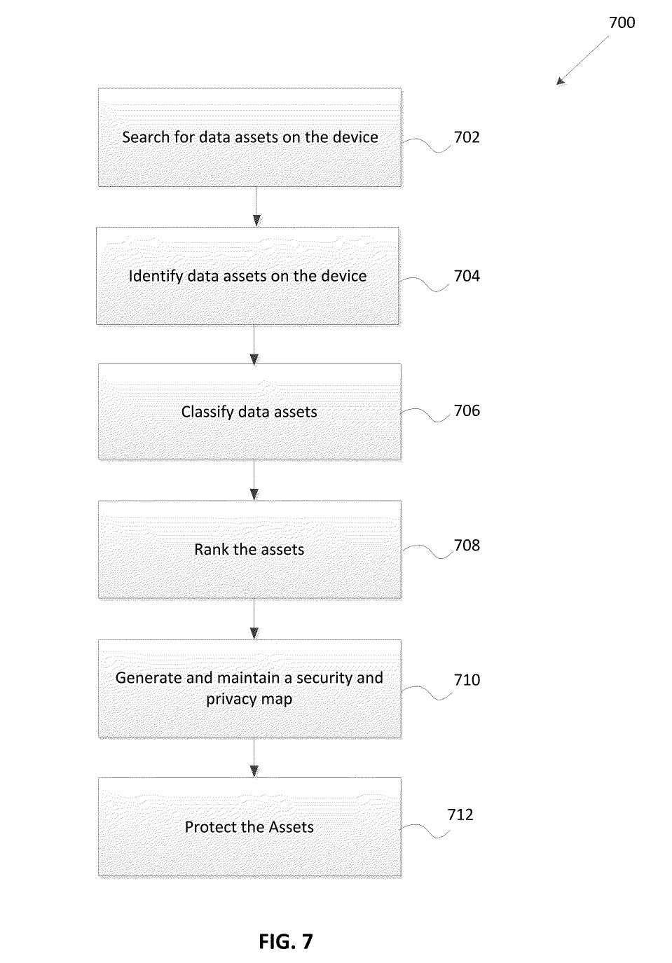

FIG. 7 illustrates a flow diagram 700 for protecting data assets on a device, in one embodiment of the invention. Many of the details of the steps in FIG. 7 have been described above, and those details can be incorporated into the specific steps in FIG. 7.

In step 702, data assets are searched on a device for protection. For example, data assets may be discovered statically and dynamically by the search module 412 on the mobile device 300. The static discovery of the assets may occur as a result of an automatic scanning event or a user based trigger. The dynamic discovery may occur as data assets are updated, e.g., new data is received or previously stored data is moved or modified. The data assets may be updated due to installation, un-installation or execution of the applications on the device. Further, the data assets may be updated due to interaction with other entities, users or applications. In some embodiments, the data assets are searched based on a policy (e.g., policies 410) set by one or more entities.

In step 704, data assets are identified after the data to be protected is discovered. For example, data assets may be identified by the data identification module 414 based on one or more attributes. Some non-limiting examples of attributes are listed in table 500 that may be used to determine a type of data asset.

In step 706, once the data assets are identified, the data assets may be classified. For example, the classification module 416 may classify the data assets into different sensitivity level (highly sensitive, sensitive, important, not sensitive) based on the policies 410, as illustrated in FIG. 5.

In step 708, the classified assets may be ranked. For example, the ranking module 420 may rank the classified assets based on different policies, as illustrated in FIGS. 6A-6B.

In step 710, a security and privacy map of the assets may be generated and maintained. For example, the map generation module 418 may generate the security and privacy map 408 that can associate various data assets, their ranking, and location for easy access, as illustrated in FIGS. 6A-6B.

In step 712, the data protection module 400 may protect the classified assets using one or more of the protection mechanisms provided by the protection mechanism module 422, e.g., encryption, de-contexting, hashing, masking, tokenization, scrubbing, etc. In some embodiments, the data protection mechanism may be selected/adjusted by a user using the user interface. In some embodiments, the data assets may be protected based on a sub-classification (e.g., state of the data).

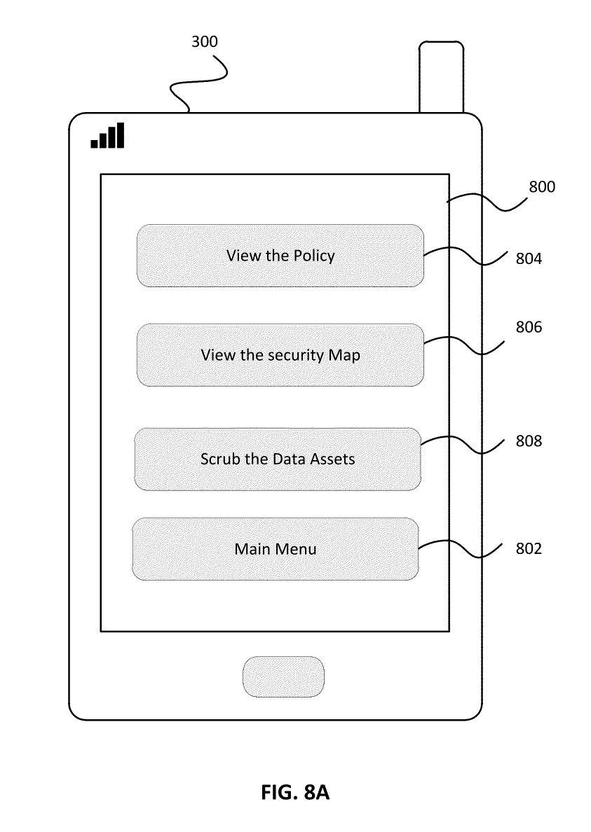

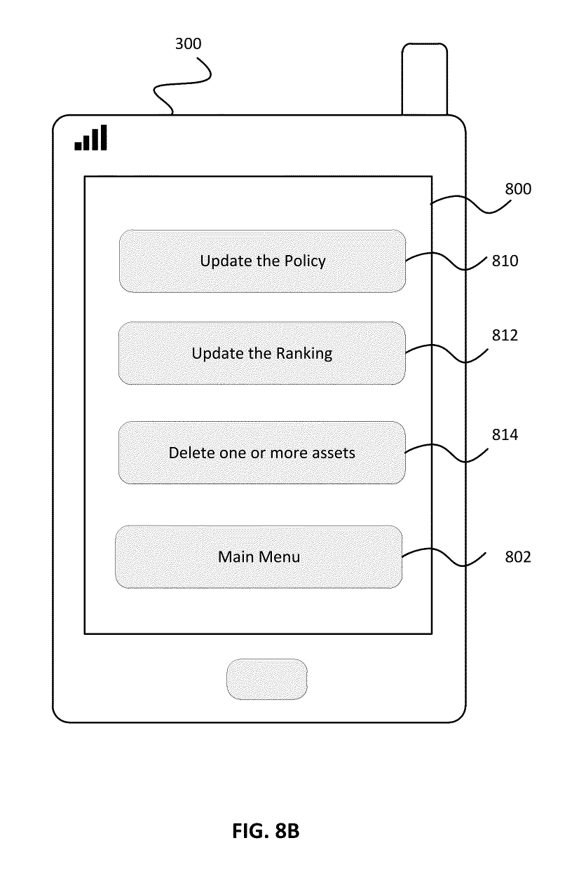

FIGS. 8A-8B illustrate a user interface provided on a mobile device, in one embodiment on the invention.

As illustrated in FIG. 8A, a user interface 800 may be provided on the mobile device 300. In one embodiment, the user interface 800 may provide different options to the user, such as, view the policy 804, view the security map 804, scrub the data assets 808, and a main menu 802.

As illustrated in FIG. 8B, the user interface 800 may also provide options to the user, such as, update the policy 810, update the ranking 812, delete one or more assets 814, and the main menu 802.

Embodiments of the invention provide intelligence to the application by being aware of the environment in which the application is downloaded, installed and/or executed on a device. Security sensitive data assets on the device may be discovered, identified, and classified based on a policy. Cryptographic controls/mechanisms may be provided based on the classification, state of the data (at-rest, in-transit, or in-use) and where the data resides on the device.

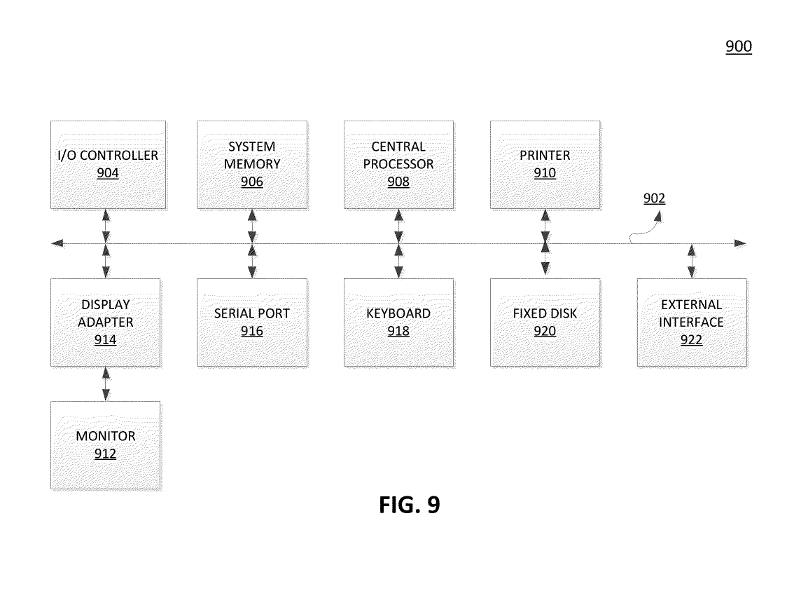

FIG. 9 is a high level block diagram of a computer system that may be used to implement any of the entities or components described herein. The subsystems shown in FIG. 9 are interconnected via a system bus 902. Additional subsystems include a printer 910, keyboard 918, fixed disk 920, and monitor 912, which is coupled to a display adapter 914. Peripherals and input/output (I/O) devices, which couple to an I/O controller 904, can be connected to the computer system by any number of means known in the art, such as a serial port. For example, a serial port 916 or an external interface 922 can be used to connect the computer apparatus to a wide area network such as the Internet, a mouse input device, or a scanner. The interconnection via the system bus 902 allows a central processor 908 to communicate with each subsystem and to control the execution of instructions from a system memory 906 or a fixed disk 920, as well as the exchange of information between subsystems. The system memory 906 and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method for protecting data assets on a computing device, the method comprising:
searching, by a data protection module run by a processor, for at least one data asset on the computing device;
identifying, by the data protection module run by the processor, the at least one data asset based on at least one attribute associated with the at least one data asset;
classifying the at least one data asset; and
generating a map using the classification of the data asset.

2. The method of claim 1, further comprising:
ranking the at least one data asset.

3. The method of claim 1,
wherein the steps of the searching, identifying and classifying are based on a policy set by one or more entities.

4. The method of claim 3, further comprising:
protecting the at least one data asset according to the policy.

5. The method of claim 4,
wherein the protecting the at least one data asset includes one or more of an encryption, de-contexting, tokenization, masking, hashing, or deletion of the data asset.

6. The method of claim 3,
wherein the one or more entities include an application owner, a user of the computing device, a financial institution, a payment processing network, or an additional service provider.

7. The method of claim 1,
wherein the data protection module is part of a downloadable application.

8. The method of claim 1,
wherein the data protection module is a standalone application module on the computing device.

9. The method of claim 3,
wherein the policy includes a sub-classification of the at least one data asset.

10. A computing device comprising:
a processor; and
a computer readable medium coupled to the processor, the computer readable medium comprising code, executable by the processor for implementing a method comprising:
searching, by a data protection module, for at least one data asset on the computing device;
identifying, by the data protection module, the at least one data asset based on at least one attribute associated with the at least one data asset;
classifying the at least one data asset; and
generating a map using the classification of the data asset.

11. The computing device of claim 10, further comprising:
ranking the at least one data asset.

12. The computing device of claim 10,
wherein the steps of the searching, identifying and classifying are based on a policy set by one or more entities.

13. The computing device of claim 12, further comprising:
protecting the at least one data asset according to the policy.

14. The computing device of claim 13,
wherein the protecting the at least one data asset includes one or more of an encryption, de-contexting, tokenization, masking, hashing, or deletion of the data asset.

15. The computing device of claim 10,
wherein the data protection module is part of a downloadable application.

16. The computing device of claim 10,
wherein the data protection module is a standalone application module.

17. The computing device of claim 10,
wherein the computing device is a mobile phone.

18. A system comprising:
a server computer; and
a computing device communicatively coupled to the server computer through a communications network, the computing device comprising a processor and a computer readable medium coupled to the processor, the computer readable medium comprising code, executable by the processor for implementing a method comprising:
searching, by a data protection module, for at least one data asset on the computing device;
identifying, by the data protection module, the at least one data asset based on at least one attribute associated with the at least one data asset;
classifying the at least one data asset; and
generating a map using the classification of the data asset.

19. The system of claim 18,
wherein the steps of the searching, identifying and classifying are based on a policy set by one or more entities.

20. The system of claim 18,
wherein the data protection module is part of a downloadable application.
